(19) United States
(12) Patent Application Publication
(10) Pub. No.: US 2026/0218742 A1
(43) Pub. Date: Jul. 30, 2026

(54) A FIXING BOLT AND A METHOD OF USING THE FIXING BOLT

(71) Applicant: Comrod AS, TAU (NO)

(72) Inventor: Velid OMEROVIC, SLEMMESTAD (NO)

(73) Assignee: Comrod AS, TAU (NO)

(21) Appl. No.: 19/145,351

(22) PCT Filed: Mar. 13, 2024
(86) PCT No.: PCT/NO2024/050062

§ 371 Date: Jul. 2, 2025

(30) Foreign Application Priority Data
Apr. 14, 2023 (NO) 20230410

(51) Int. Cl. F16B 13/08; A63B 27/00

(52) U.S. Cl. CPC F16B 13/0808; A63B 27/00

(57) ABSTRACT

A fixing bolt is for fixing in a wall, wherein the back of the wall forms an inaccessible space, the fixing bolt has a center axis and a first portion, wherein a locking body is at least rotatably or displaceably connected to the first portion of the bolt as the first portion of the bolt and the locking body are arranged to be inserted into a bore in the wall, wherein the locking body is rotated by means of gravity into an active position, in which the locking body projects diametrically from the bolt on two opposite sides, wherein the locking body, in its active position, is arranged to come into abutment against the inside of the wall. The locking body is at least rotatable or displaceable around a transverse portion, and the transverse portion is formed from and is integral with the material of the first portion of the bolt.

### CROSS-REFERENCE TO RELATED APPLICATIONS

This application is the U.S. national stage application of International Application No. PCT/NO2024/050062, filed Mar. 13, 2024, which international application was published on Oct. 17, 2024, as WO 2024/215205 in the English language. The International Application claims priority to Norwegian patent application No. 20230410, filed on Apr. 14, 2023. The international application and Norwegian application are both incorporated herein by reference, in their entirety.

### FIELD

This invention relates to a fixing bolt for fixing in a wall, wherein the back of the wall forms an inaccessible space, for example in a tubular mast, and wherein the fixing bolt has a centre axis and a first portion, and wherein a locking body is at least rotatably or displaceably connected to the first portion of the fixing bolt as the first portion and the locking body are arranged to be inserted into a bore in the wall, as the locking body is rotated by means of gravity into an active position, in which the locking body projects diametrically from the fixing bolt on two opposite sides, and wherein the locking body, in its active position, is arranged to come into abutment against the inside of the wall. The invention also comprises a method of carrying out the invention.

### BACKGROUND

When bolts are being fixed, for example in relatively thin walls where there is no access to the back, it is common to use a lock that is brought into a locking position by means of gravity. The same technique is also used when fixing in thicker walls in which threading is difficult, for example in concrete.

A typical example of fixing in a thin wall is when steps are needed in a hollow composite mast. The special part of the document describes such a solution in detail.

Several mechanisms are known in which gravity is used to bring a locking body into the desired position in or behind a wall after the bolt has been pushed into a bore in or through the wall.

Common to these mechanisms is that the locking body is rotated or displaced around a pin or shaft which has been fitted transversally to the longitudinal direction of the bolt. The space conditions cause the pin or shaft to have a modest cross section and thereby relatively little strength. It is a recurring problem that overloading such slender pins or shafts leads to insecure fixing and limited durability.

NO 343846 discloses a step for mounting in a tubular mast, wherein, during mounting, an end portion of the step is arranged to be inserted into an opening in a mast wall, and wherein the step is then fixed to the mast by a locking element of the step being displaced axially towards the mast wall. The end portion of the step is provided with a lock which, after having been moved at least partially through the opening, is arranged to be activated between a locked position and an unlocked position by means of gravity.

DE 102006052664 deals with a device for fixing supporting brackets to building walls. It consists of a round rod which is insertable into a wall bore. The round rod has a slot, there being a hole at the end of the slot, to which a locking arm is linked. The locking arm has a slot and a bolt extending through it via the bore, as the slot is so dimensioned that the locking arm can be swung into the slot, and wherein a portion of the locking arm, which has the slot, is heavier than the part of the locking arm that is in the slot of the round rod.

### SUMMARY

The invention has for its object to remedy or reduce at least one of the drawbacks of the prior art or at least provide a useful alternative to the prior art.

The object is achieved through the features that are specified in the description below and in the claims that follow. The invention is defined by the independent claims. The dependent claims define advantageous embodiments of the invention.

In a first aspect, the invention relates more specifically to a fixing bolt for fixing in a wall, wherein the back of the wall forms an inaccessible space, for example in a tubular mast. The fixing bolt has a centre axis and a first portion and a locking body which is at least rotatably or displaceably connected to the first portion of the fixing bolt. The first portion of the fixing bolt and the locking body are arranged to be inserted into a bore in the wall, as the locking body is rotated by means of gravity into an active position, in which the locking body projects diametrically from the fixing bolt on two opposite sides, as the locking body, in its active position, is arranged to come into abutment against the inside of the wall, and wherein the locking body at least is rotatable or displaceable around a transverse portion, as the transverse portion is formed from and is integral with the material of the first portion of the fixing bolt.

In its active position, the locking body may abut against the transverse portion.

The locking body may be provided with a recess, the transverse portion being in the recess.

The material of the locking body surrounding the recess may have its largest thickness at a locking portion.

Before being prepared, the locking body may be provided with a closable slot extending into the recess.

The slot may be closable by deformation of the material of the locking body.

The locking body, which is typically annular, may comprise a guiding portion in addition to the locking portion. The locking portion may be heavier than the guiding portion.

In a second aspect, the invention relates more specifically to a method for fixing a fixing bolt in a wall, wherein the back of the wall forms an inaccessible space, for example in a tubular mast. The fixing bolt has a centre axis and a first portion, as a locking body is at least rotatably or displaceably connected to the first portion of the fixing bolt, and wherein the first portion of the fixing bolt and the locking body are arranged to be inserted into a bore in the wall. The locking body is rotated by means of gravity into an active position in which the locking body projects diametrically from the fixing bolt on two opposite sides, and wherein the locking body, in its active position, is arranged to come into abutment against the inside of the wall, and wherein the locking body, after having been arranged in the wall, at least is rotated or displaced around a transverse portion, wherein the transverse portion is formed from and is integral with the material of the first portion of the fixing bolt.

The method may comprise positioning the transverse portion in a recess in the fixing bolt.

The method may further comprise closing a slot before use, as the slot is arranged in the locking body and extending through the material of the locking body into the recess of the locking body.

The method may also comprise inserting the first portion of the fixing bolt together with the locking body through a bore, after which gravity causes the locking body to be rotated around the transverse portion until the locking portion of the locking body is near the inside of the wall below the first portion.

The method may comprise rotating the fixing bolt around its centre axis until the locking portion of the locking body is near the inside of the wall above the first portion, after which gravity displaces the locking portion into an opening in the first portion.

The method may also comprise moving the fixing bolt axially until the locking portion comes into abutment against the inside of the wall and against the transverse portion.

A fixing bolt and method according to the invention make it possible for fixing bolts of this kind to be formed for absorbing considerably greater forces than prior-art fixing bolts. Two conditions make this possible. Firstly, the transverse portion according to the invention has a considerably larger cross-sectional area than corresponding prior-art pins or shafts. In addition, the locking body is formed in such a way that a thicker locking portion can be moved through a bore in a wall together with the first portion of the fixing bolt. The method of the invention gives at least one way of bringing the fixing bolt between the active position and the inactive position.

### BRIEF DESCRIPTION OF THE DRAWINGS

In what follows, examples of preferred embodiments are described, which are visualized in accompanying drawings, wherein:

FIG. 1 shows a section of a mast with steps;

FIG. 2 shows a plan view of the mast of FIG. 1;

FIG. 3 shows a step in perspective, on a larger scale;

FIG. 4 shows a locking body in perspective;

FIG. 5 shows a step, partially in section, during insertion into a bore;

FIG. 6 shows the step as the locking body has been rotated downwards by means of gravity, and where a locking portion is near the inner wall of the mast;

FIG. 7 shows the step after it has been rotated around its centre axis until the locking portion is above the step;

FIG. 8 shows the step after the locking portion has been inserted into the opening of the step; and

FIG. 9 shows another embodiment wherein a bracket is fixed to a wall by means of a fixing bolt.

### DETAILED DESCRIPTION OF THE DRAWINGS

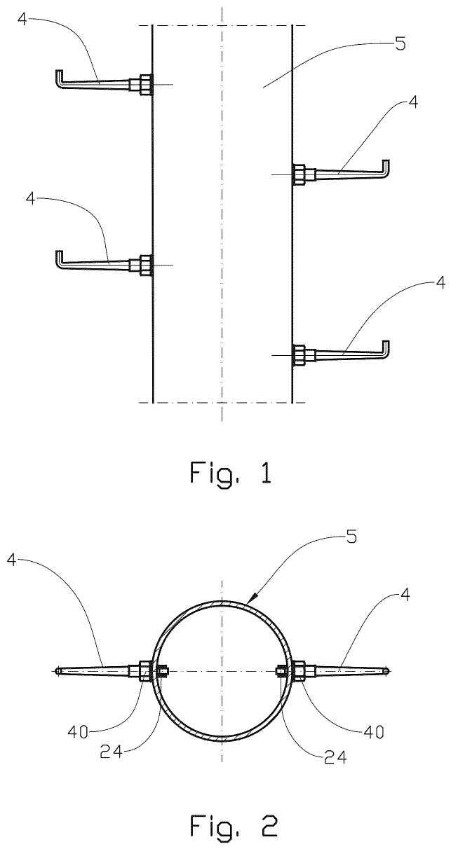

In the drawings, the reference numeral 1 indicates a fixing bolt in the form of a step 4 which is fixed to a hollow mast 5. In FIG. 1, a pattern of steps 4 that are arranged in the mast 5 to give easy access to the upper portion, not shown, of the mast 5 is shown.

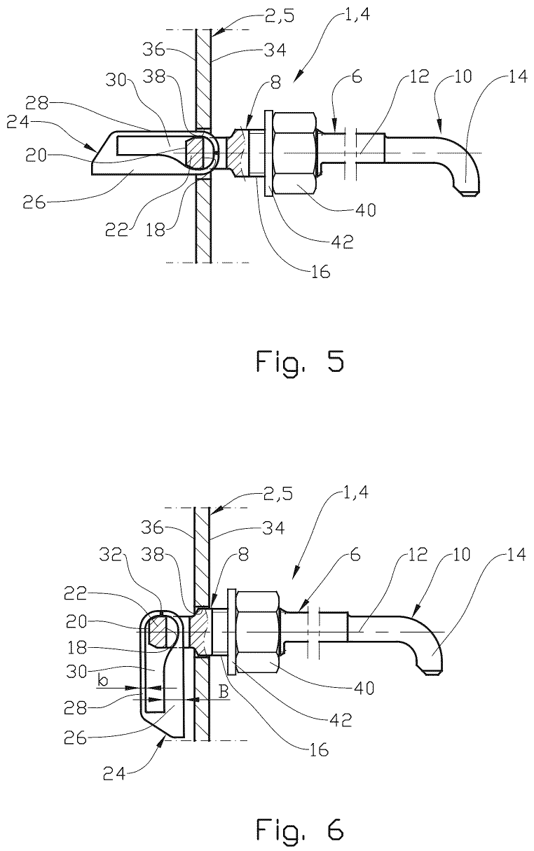

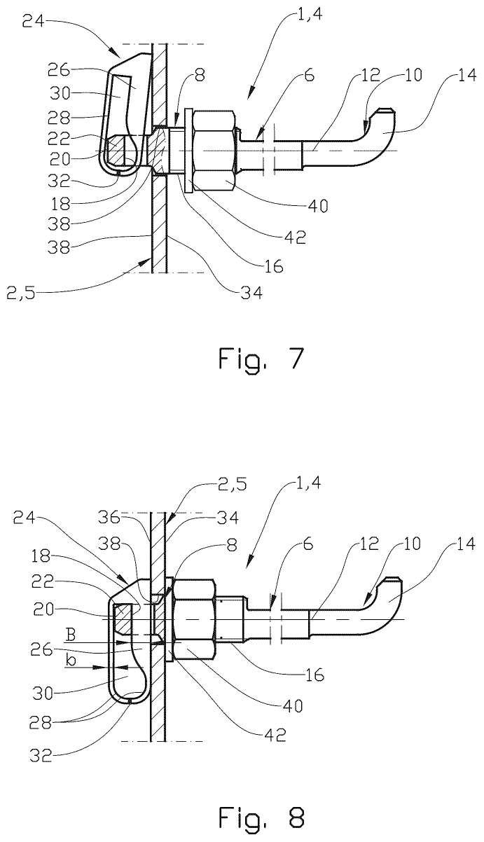

In this preferred exemplary embodiment, the step 4 comprises a middle step portion 6, see FIGS. 5-8, which, in the position of application, is outside the mast 5, and which is arranged to absorb forces from a person, not shown, climbing the mast 5. The step 4 also has an inner, first portion 8 and an outer, second portion 10 and a centre axis 12. A hook 14 at the second portion 10 is arranged to prevent unintended sliding on the step portion 6.

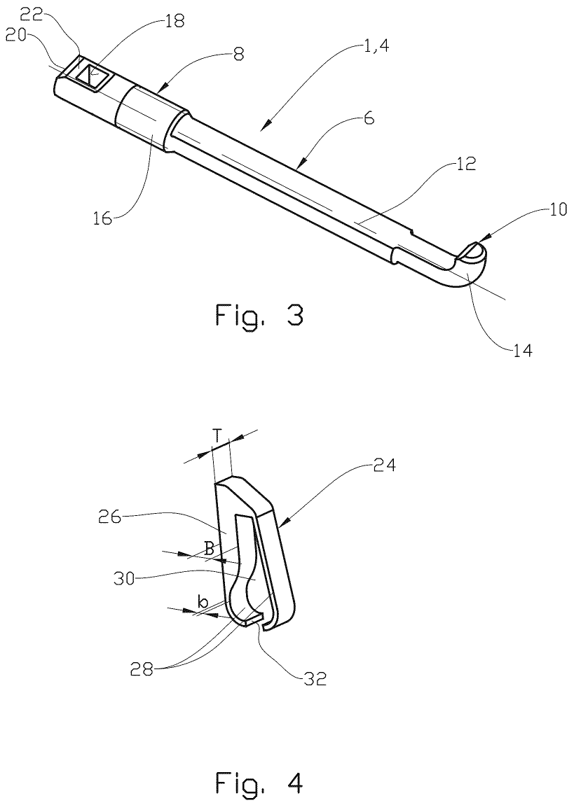

At its first portion 8, the step 4 is provided with external threads 16, see FIGS. 3 to 9. A central, diametrical, through opening 18 is arranged near the free end 20 of the first portion 8, see FIG. 6, for example. The material that is between the opening 18 and the free end 20 forms a transverse portion 22. The transverse portion 22 is an integral part of the material of the step 4.

A locking body 24, which is typically annular, is formed with a locking portion 26 and a guiding portion 28. The locking portion 26 normally has a larger width B than the width b of the guiding portion 28 and a constant thickness T, see FIG. 2. In the installed position, the locking portion 26 and the guiding portion 28 surround a recess 30 in the locking body 24. In the installed position, the transverse portion 22 is in the recess 30. The locking portion 26 of the locking body 24 is designed to fit in the opening 18.

The locking body 24 has a closable slot 32 extending from the outside into the recess 30. See FIG. 4. The purpose of the slot 32 is that, during preparation of the step 4, the locking body 24 is to be inserted over the transverse portion 22. The slot 32 is subsequently closed, in this preferred exemplary embodiment by deforming the material of the guiding portion 28.

The mast 5 has an outside 34 and an inside 36. A through bore 38 extends between the outside 34 and the inside 36.

Before installation, the step 4 is prepared by the locking body 24 being inserted through the opening 18 in the first portion 8 and over the transverse portion 22, after which the slot 32 is closed.

A locking nut 40 is screwed onto the threads 16, preferably with a washer 42.

The locking body 24 is brought into a position, as shown in FIG. 5, in which it is moved through the bore 38. When the locking body 24 is on the inside 36 of the mast, the locking body 24 will be rotated, owing to gravity, into a hanging position mainly parallel to the mast 5, as shown in FIG. 6.

By rotating the step 4 around its centre axis 12, typically about 180 degrees, the locking body 24 is brought into a position in which the locking portion 26 is at a height level mainly above the first portion 8. Because of a weight difference between the locking portion 26 and the guiding portion 28, rotation of the locking body 24 away from the inside 36 of the mast 5, whereby the locking portion 26 falls into the opening 18 of the first portion 8, see FIG. 8, is avoided.

The locking portion 26 projects on opposite sides of the first portion 8. When the locking nut 40 is tightened against the outside 34 of the mast 5, the locking portion 26 comes into abutment against the inside 36 of the mast 5 and against the transverse portion 22.

In dismantling, the step 4 is rotated around its centre axis 12, whereby the locking piece 24 falls down into a position in which the step 4 together with the locking piece can be pulled out through the bore 38, corresponding to the position that is shown in FIG. 5.

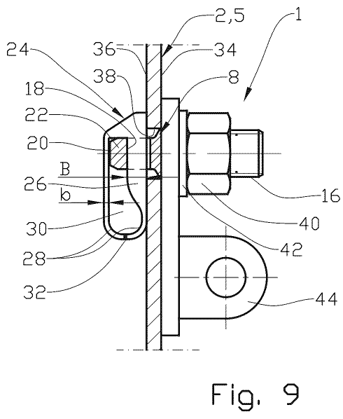

In another embodiment, which is shown in FIG. 9, a bracket 44 is fixed to a wall by means of a fixing bolt 1.

1. A fixing bolt for fixing in a wall, wherein the back of the wall forms an inaccessible space, and wherein the fixing bolt has a center axis and a first portion, and wherein a locking body is at least rotatably or displaceably connected to the first portion of the fixing bolt as the first portion of the fixing bolt and the locking body are arranged to be inserted into a bore in a wall as the locking body is rotated by means of gravity into an active position, in which the locking body projects diametrically from the fixing bolt on two opposite sides, and wherein the locking body, in its active position, is arranged to come into abutment against the inside of the wall, wherein the locking body is at least rotatable or displaceable around a transverse portion, wherein the transverse portion is formed from and is integral with the material of the first portion of the fixing bolt.

2. The fixing bolt in accordance with claim 1, wherein the locking body, in its active position, abuts against the transverse portion.

3. The fixing bolt in accordance with claim 1, wherein the locking body is provided with a recess and wherein the transverse portion is in the recess.

4. The fixing bolt in accordance with claim 1, wherein the material of the locking body that surrounds the recess has its largest thickness at a locking portion.

5. The fixing bolt in accordance with claim 1, wherein, before being prepared, the locking body is provided with a closable slot into the recess.

6. The fixing bolt in accordance with claim 1, wherein the slot is closable by deformation of the material of the locking body.

7. The fixing bolt in accordance with claim 1, wherein the locking body is provided with a guiding portion, and wherein the locking portion of the locking body is heavier than the guiding portion of the locking body.

8. The fixing bolt in accordance with claim 1, wherein the locking portion, in its active position, is in an opening.

9. A method for fixing a fixing bolt in a wall, wherein the back of the wall forms an inaccessible space, the method comprising providing a fixing bolt having a center axis and a first portion, and a locking body at least rotatably or displaceably connected to the first portion of the fixing bolt, and inserting the first portion of the fixing bolt and the locking body into a bore in the wall, as the locking body is rotated by means of gravity into an active position, in which the locking body projects diametrically from the fixing bolt on two opposite sides, and wherein the locking body, in its active position, is arranged to come into abutment against the inside of the wall, wherein the locking body, after having been arranged in the wall, is at least rotated or displaced around a transverse portion, wherein the transverse portion is formed from and is integral with the material of the first portion of the fixing bolt.

10. The method in accordance with claim 9, wherein the transverse portion (22) is placed in a recess (30) in the fixing bolt (1).

11. The method in accordance with claim 9, wherein a slot is closed before use as the slot is arranged in the locking body and extends through the material of the locking body into the recess of the locking body.

12. The method in accordance with claim 9, wherein the first portion of the fixing bolt together with the locking body is inserted through a bore, after which gravity causes the locking body to be rotated around the transverse portion until the locking portion of the locking body is near the inside of the wall below the first portion.

13. The method in accordance with claim 9, wherein the fixing bolt is rotated around its center axis until the locking portion of the locking body is near the inside of the wall above the first portion, after which gravity displaces the locking portion into an opening in the first portion.

14. The method in accordance with claim 9, wherein the fixing bolt is displaced axially until the locking portion comes into abutment against the inside of the wall and against the transverse portion.

15. The fixing bolt in accordance with claim 2, wherein the locking body is provided with a recess and wherein the transverse portion is in the recess.

16. The fixing bolt in accordance with claim 2, wherein the material of the locking body that surrounds the recess has its largest thickness at a locking portion.

17. The fixing bolt in accordance with claim 3, wherein the material of the locking body that surrounds the recess has its largest thickness at a locking portion.

18. The fixing bolt in accordance with claim 2, wherein, before being prepared, the locking body is provided with a closable slot into the recess.

19. The fixing bolt in accordance with claim 3, wherein, before being prepared, the locking body is provided with a closable slot into the recess.

20. The fixing bolt in accordance with claim 4, wherein, before being prepared, the locking body is provided with a closable slot into the recess.
